(19) United States
(12) Patent Application Publication
(10) Pub. No.: US 2014/0123311 A1
(43) Pub. Date: May 1, 2014

(54) PROGRESSIVE UNLOCKING OF E-BOOK CONTENT

(71) Applicant: Bookboard, Inc., Burlingame, CA (US)

(72) Inventors: Nigel Leigh Pegg, San Francisco, CA (US); Alexander John Magee, San Francisco, CA (US)

(73) Assignee: Bookboard, Inc., Burlingame, CA (US)

(21) Appl. No.: 14/070,313

(22) Filed: Nov. 1, 2013

Related U.S. Application Data
(63) Continuation-in-part of application No. 13/631,980, filed on Sep. 29, 2012.

(51) Int. Cl. G06F 21/60

(52) U.S. Cl. CPC G06F 21/60
USPC 726/27

(57) ABSTRACT

Approaches for progressively unlocking e-book content are provided wherein access is granted to a first set of e-books, wherein the first set is a subset of a second set of e-books to which access is restricted. Data is received indicating that one of the e-books in the first set has been read, and then it is determined whether access to an e-book in the second set should be granted. If so, access to an e-book in the second set is granted, wherein the e-book in the second set is chosen based upon an analysis of previously-read e-books in the first set.

### CLAIM OF PRIORITY AND RELATED APPLICATION DATA

This application is a continuation-in-part of, and claims priority to, U.S. non-provisional patent application Ser. No. 13/631,980, filed Sep. 29, 2012, entitled “Creating And Consuming Streaming E-Book Content,” the contents of which are hereby incorporated by reference for all purposes as if fully set forth herein.

### TECHNICAL FIELD

The subject matter disclosed herein generally relates to the processing of data. Specifically, the present disclosure addresses systems, devices and methods directed to progressive unlocking of e-book content.

### BACKGROUND

The proliferation of mobile computing devices has caused a massive shift in how people acquire and read books. Instead of purchasing a physical volume, more and more consumers choose to purchase electronic books (“e-books”) and read them on their phone, tablet, Kindle, or similar device.

Most e-book retailers such as Amazon, Apple, Barnes & Noble and others offer “a la carte” e-book purchasing, whereby customers choose a e-book at a time from a massive inventory of digital content. Other providers offer a rental or subscription model, which is akin to a library with a monthly service charge. There are also curated library offerings that select and offer a limited group of books that the target reader may choose from; for example, children's books or mystery novels.

### BRIEF DESCRIPTION OF THE DRAWINGS

Some embodiments are illustrated by way of example and not limitation in the figures of the accompanying drawings.

FIG. 1 is a block diagram 100 illustrating an example pace of progressively unlocking e-book content as part of an incentive system, according to some example embodiments.

FIG. 2 is a block diagram 200 illustrating the progression of reading skills over time, according to some example embodiments.

FIG. 3 is a flowchart 300 illustrating an example technique for recommending e-books as part of a progressive unlocking approach, according to some example embodiments.

FIG. 4 is a flowchart 400 illustrating the steps of an example approach for progressive unlocking of e-book content, according to some example embodiments.

FIG. 5 is a block diagram 500 illustrating components of a machine, according to some example embodiments, able to read instructions from a machine-readable medium and perform any one or more of the methodologies discussed herein.

### DETAILED DESCRIPTION

Example methods and systems are directed to progressive unlocking of e-book content. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

In an example embodiment, a library of children's e-books is chosen and a subset of the library is presented to a user, and based on the user's actions, portions of the e-book library previously hidden from the user are revealed (“unlocked”). The particular e-books chosen to be unlocked are selected based on numerous criteria. While the application primarily discussed the progressive unlocking of e-book content in the context of a children's e-book embodiment, it is understood that the approaches described herein are not limited to e-books, nor to any particular genre or type of reading content.

According to an embodiment, a subset of a complete e-book library is presented to a user (perhaps a child or a child's parent) upon initiating an account with an example embodiment. A subset, rather than the entire library, is presented for numerous reasons. Not all e-book content is appropriate for a child at a given age, with a given reading level and with particular interests. Also, too much choice can be overwhelming at first. By restricting the amount of content available to a user, the user is more apt to choose an e-book and begin reading, after which the approaches of progressively unlocking particular e-book content may be implemented.

In one embodiment, a user completes a profile as part of the sign-up process. Demographic information such as age and gender is used to identify a subset of approximately 25 e-books that are age-appropriate, with a relatively high variance in reading level and subject matter. This initial subset is designed to offer enough choices to a user so that several of the e-books appeal to the user, while avoiding the problems incident to providing an overwhelming number of choices at the beginning In an embodiment, this initial subset is visually presented on a display with a “virtual shelf” user interface design.

For each profile created, an example approach tracks the reading history for the user. This may include data such as what books the user chooses, their progress on the books, the time the user spends, both on individual books and on the system as a whole, the subject and reading level of the books, the reading ability of the user over time, and so on.

The initial subset is gradually added to via several approaches. One example is that as new e-books are added to the library as a whole, a small subset (e.g., 2-3) of the new e-books is added to the user's available choices upon a future login to the system. Another example is the progressive unlocking of content as part of an incentive system, as described more fully herein. Another example is that e-book recommendations for e-books not currently available to a user as part of their “library” are periodically sent to a user, in one instance where a user has lapsed in their reading. A small set of e-books as yet unlocked may be suggested to a lapsed user, allowing them to unlock the e-books upon their subsequent logging in.

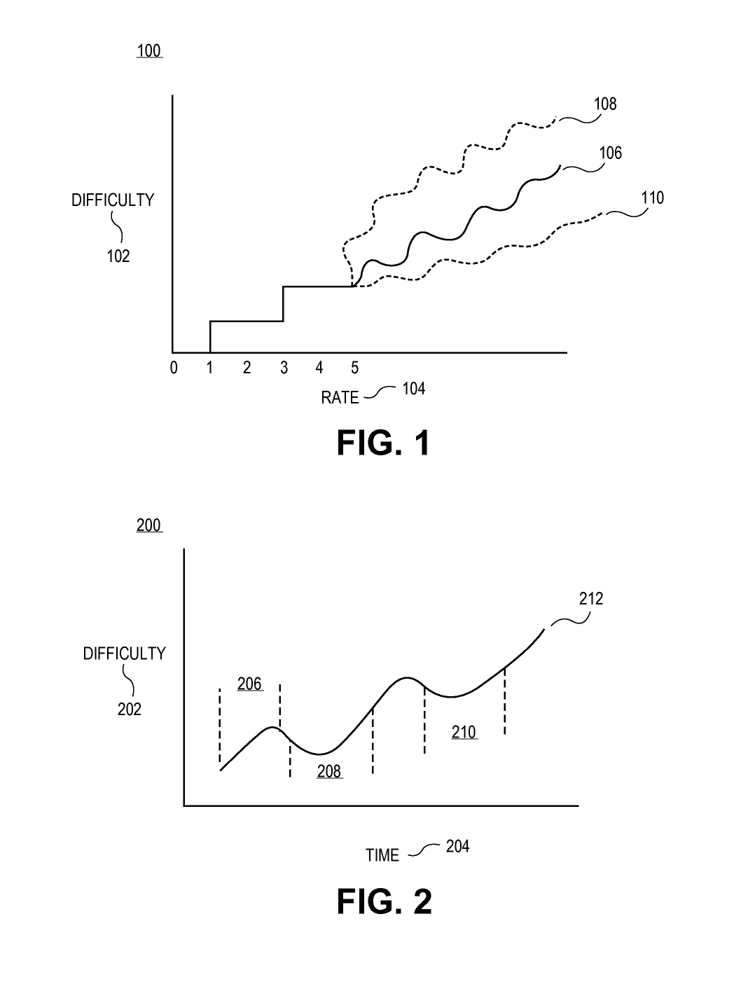

FIG. 1 is a block diagram 100 illustrating an example pace of progressively unlocking e-book content as part of an incentive system, according to some example embodiments. In the example of FIG. 1, the vertical axis 102 represents the difficulty of unlocking new e-book content (e.g., the “number of books you need to complete” in order to unlock the next reward), while the horizontal axis 104 represents the rate of reading, expressed in one example by number of e-books read over time. In an example, the “time” constitutes a rolling window, such as a week. For example, a user who has read one e-book in the last week would be placed at “1” on the rate scale, while a user who has read one e-book two weeks ago would be a “0” on the rate scale.

As the user begins reading, an example approach generates a “reading challenge” that comprises a number of books to be completed by the user before being rewarded with a new e-book to “unlock.” Upon completing a challenge, a new e-book is unlocked and a new challenge is created.

In an example, the pace of the challenge resulting in the unlocking of new e-book content 106 is faster at first. This allows the system to uncover the user's preferences, which are relevant for the recommendation aspect of the described approaches, as well as offering a more enticing reward schedule for the beginning user, by unlocking new e-books that may accord with the user's preferences and interests. In the example illustrated by the graph 100, the challenge is mild at first and may follow a simple step function; for example, if the user reads one e-book, they unlock one e-book into their library. As the user progresses, the challenge may become more difficult. It may take reading two books to unlock one new e-book, and so on.

Depending on the user's pace of reading, the difficulty of the amount of reading necessary to unlock content varies. The incentive should be maintained at an appropriate distance. If a user is reading a lot of books, then she may be self-motivated and less of an incentive may be required. In other words, if a user is reading at a high rate, then the challenge difficulty increases, in order to properly motivate the user to continue that high rate of engagement. A user who is reading at a lower rate may need the reward of new unlocked content held much closer in front of them.

While in one example the progressive unlocking schedule follows a step function, some variation may be incorporated into the challenge and unlocking approaches. For example, the unlocking rate may deviate from a simple step function and proceed in a more unpredictable fashion, although maintaining a generally linear slope. This provides an aspect of unpredictable variation that keeps users interested.

The rate and slope of the unlocking schedule may increase or decrease in some embodiments. A new reading challenge fluctuates in difficulty based upon various factors. One, how long has the user been using the system? If this is the first e-book being read, then the challenge schedule is “one for one,” as described above. If the user has been using the system for a while, then the challenge/reward schedule varies from the simple step function. Two, how much has the user been using the system lately? If the user has lapsed in reading, then the challenge should be made easier to re-engage the user. Conversely, if the user has been extremely engaged with the system, then a more difficult challenge may be appropriate to maintain interest. Three, what is the user reading in terms of difficulty for their reading level/age/etc.? If the user is reading chapter books with hundreds of pages, then the challenge could be scaled much lower. If the user is reading short picture books, then a more lengthy challenge may be appropriate.

In an example, the determination of reading difficulty and reading level may be calculated via using a readability test, as known in the art. Readability tests, readability formulas, or readability metrics are formulae for evaluating the readability of text, usually by counting syllables, words, and sentences. Readability tests are often used as an alternative to conducting an actual statistical survey of human readers of the subject text (a readability survey); however, in various embodiments, human curation of e-books is envisioned.

The application of a useful readability test protocol will give a rough indication of a work's readability, with accuracy increasing when finding the average readability of a large number of works. The tests generate a score based on characteristics such as statistical average word length (which is used as an unreliable proxy for semantic difficulty) and sentence length (as an unreliable proxy for syntactic complexity) of the work, although other characteristics of the work may be utilized, such as word density and overall length.

A list of readability tests which may be utilized in various embodiments may include, but not be limited to: Accelerated Reader ATOS; Automated Readability Index (ARI); Coleman-Liau Index; Dale-Chall Readability Formula; Flesch Reading Ease; Flesch-Kincaid Grade Level; Fry Readability Formula; Gunning-Fog Index; Lexile Framework for Reading; Linsear Write; LIX; Raygor Estimate Graph; SMOG (Simple Measure Of Gobbledygook); and Spache Readability Formula. Those skilled in the art would be aware of emerging approaches to measure readability.

The slope of the challenge/reward function may be shifted, as indicated by FIG. 1. For example, the slope may increase 108, thereby increasing the difficulty of the challenge and requiring more effort to unlock new e-book content. This may occur, as stated earlier, if the user has been using the system for a long time, has been extremely engaged with the system, and/or is reading shorter or less lexically complex material. The slope may decrease 110, thereby lowering the difficulty of the challenge and requiring less effort to unlock new e-book content in the opposite situations. For example, a user is liable to get a reward of unlocked content more quickly if they are reading longer or more lexically complex material material.

Once a new e-book is unlocked, the e-book is then tracked as part of the user's library (collection) and made available for the user to select at will. In general, reading is rewarded with more choice in content to consume.

As will be discussed herein with regard to example recommendation approaches, one aspect of a user's reading that is tracked by the system is the progression a user follows as she completes more challenging material for her reading level.

Via observation and research, it has been determined that younger children may be measured as reading more “challenging” books than older children due to the fact that the younger children are reading with their parents. When the same children begin to read on their own, the measure of difficulty of their reading material tends to trend downwards for a period of time. Once the child becomes more proficient at reading on their own, they progress to more difficult material, such as chapter-based books, and their reading difficulty measure trends upward.

These types of trends are illustrated in FIG. 2, which is a block diagram 200 illustrating the progression of reading skills over time, according to some example embodiments. The vertical axis 202 represents the difficulty of reading material, which may be measured by various approaches such as word length, word density, average reading level, and/or other quantitative or qualitative approaches. In an example, every e-book in the catalog is scored with a quantitative measure of difficulty. The horizontal axis 204 is time. The time may be a rolling window of time, as with FIG. 1, or may be an absolute measure.

In FIG. 2, the graph represents a child's progression through material of increasing difficulty over time. At the beginning, a child may achieve a quick rise in consuming material of greater difficulty 206. This often corresponds to a child reading a guided picture e-book, perhaps with the assistance of his parents. The graph in the example of FIG. 2 then proceeds through a decline in difficulty 208, which may correspond to a child beginning to read on their own and perhaps graduating from guided picture books to simple texts. The graph then rises as the child achieves proficiency with that material, only to decline again 210, perhaps as the child begins to read chapter books of moderate difficulty for the first time.

While the progressive unlocking of content operates as an incentive, another component of the example approaches involve a recommendation engine that works in concert with the progressive unlocking incentive.

Simply utilizing a recommendation approach that is based on a collaborative filter or a “more like this” scheme is insufficient when dealing with a young reader whose reading ability is changing over time. The skill progression that a child goes through as she reads more books is one aspect needed to choose appropriate material to potentially unlock as part of the incentive structure. In an example, the system only chooses to unlock e-books to which the user doesn't currently have access.

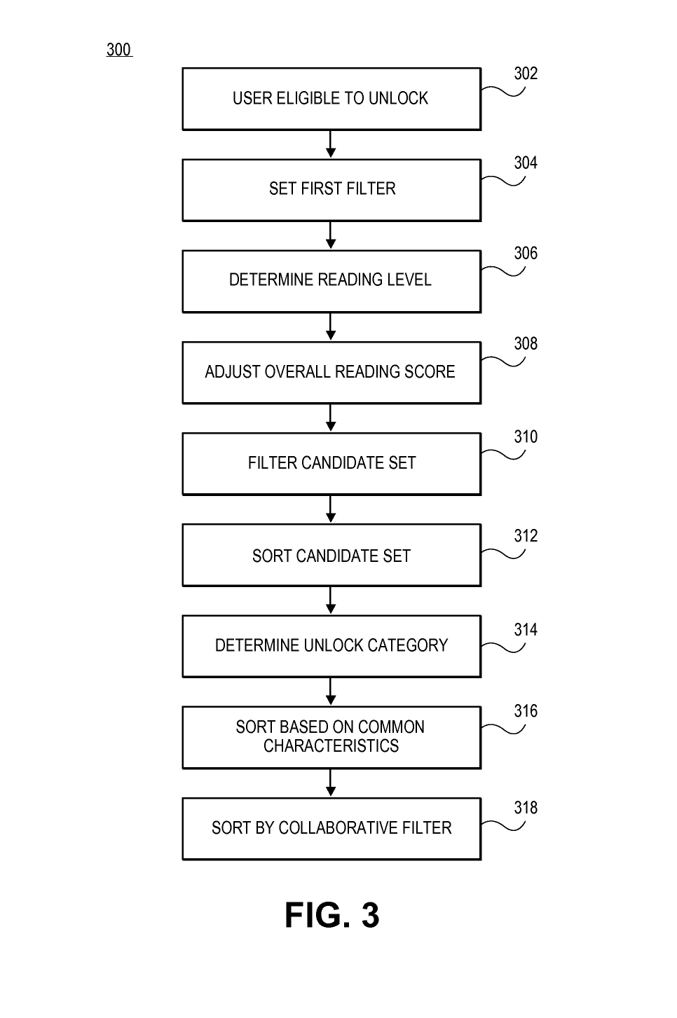

FIG. 3 is a flowchart 300 illustrating an example technique for recommending e-books as part of a progressive unlocking approach, according to some example embodiments. One approach tracks a user's reading history and utilizes numerous dimensions as part of a decision-making process that results in determining which e-book is part of a set of books that may be unlocked next.

At 302, a determination is made that the user is eligible to unlock an e-book from the library.

At 304, a first filter is set whereby the e-book chosen to be unlocked cannot be in the user's library. In an example, the entirety of the e-book library is scanned and all e-books that match this criteria (i.e., already been unlocked and made available to the user) are excluded. In other examples, this filter may be combined with other filters as described herein, or may be excluded.

At 306, a determination is made regarding the aggregated reading level of the user. In an example, this determination is made based on a rolling window of the last N books read by the user. The set of books used for this step are evaluated based on quantitative scoring criteria; for example, a lexical score that takes into account each e-book's vocabulary, sentence structure, thematic content, word density, etc. For the last N books read, these scores are averaged to give an overall reading level score for the user. This score is used as a filter for choosing the subset of books from which the next unlockable e-book is chosen. By utilizing a rolling time window, the aspect of reading progression over time is introduced into the example recommendation approach.

At 308, the overall reading level score is adjusted. This may be based on various criteria; for example, if a reader has been reading more than a certain number of e-books over a particular time period, then the overall reading level score may be adjusted upwards (i.e., more difficult material is called for). If the reader has been reading less than a certain threshold of books, then the overall reading level score may be adjusted downwards. By so doing, variation on the current reading level is achieved. While a child's reading level can go up or down, as discussed with reference to FIG. 2, it generally trends upward. If the user chooses and reads the e-book chosen via the example techniques, then the score of the chosen e-book will be included in the evaluation that results in the next unlockable e-book being chosen, and so on. This slightly-upwardly-trending difficulty offers the opportunity for the reader to progress to more difficult content via a progressive unlocking approach. As discussed with reference to FIG. 2, the variation of difficulty of the next book to be unlocked is carefully managed by an embodiment. While a child's reading level can go down and trend back upwards, the approaches herein do not always increase the difficulty of the next book to be unlocked. Variation may be introduced if the user is engaging with a difficult book or encountering an inflection point in reading skill.

At 310, the subset of e-books from the entire library that comprise the possible “next e-book to be unlocked” is filtered according to steps 304-308. The scope of the available content is narrowed down to a “candidate set,” which may also be referred to herein as a “possible set.”

At 312, the last N books read by the user are analyzed for common characteristics, and certain books in the possible set are sorted (i.e., promoted or demoted) in the ordering of the possible set. For example, if a majority of the last N books read are “read-to-me” audio narrated e-book (i.e., an e-book that is read by the e-book device to a user, often in response to user input), then audio narrated books in the possible set are promoted, for example sorted to the top of the possible set.

At 314, a determination is made regarding whether the upcoming unlock is a “special” unlock; e.g., every 4^{th} unlock is a “special” unlock. This criteria may be expressed in a frequency or be based on other criteria. If the upcoming unlock is a “special” unlock, then all books in the possible set that have been assigned a particular designation are sorted to the top of the set. For example, certain books may be designated as “premium” books, in one example meaning that a e-book has been human-curated as being qualitatively a better than average e-book. In this example, if the upcoming unlock is the Nth unlock, then all “premium” books are promoted, for example sorted to the top of the possible set. This provides a mechanism for ensuring that not all potential unlock choices are based on criteria like theme. Via this approach, the “best” e-book is bubbled to the top as long as it meets the requirements of the aforementioned filters (i.e., is age-appropriate, is not already unlocked, etc.).

At 316, the aggregated thematic content chosen by the user over the last N books read is calculated. For example, the relative number of themes and/or elements that the last N books have in common is calculated, and then the possible set of e-books is sorted based on the e-books with the most thematic matches with the last N books read. Examples themes and/or elements could be: animals, mystery, geographic location, a particular character, author, is it part of a series, etc.

At 318, the possible set is sorted based on a collaborative filter. In an example, this comprises a filter of “readers who read the last N books you read also read X.” This means that of the possible set, the ultimate recommendation should be biased to an e-book that is popular among other readers who also read books in common with the current user.

According to an embodiment, steps 304-308 are pattern-matching filters that operate to “throw away” e-books that shouldn't be in the current possible set. Steps 312-318 are sorting functions that, while not eliminating the e-book from the candidate set, lower the probability of that e-book being finally chosen.

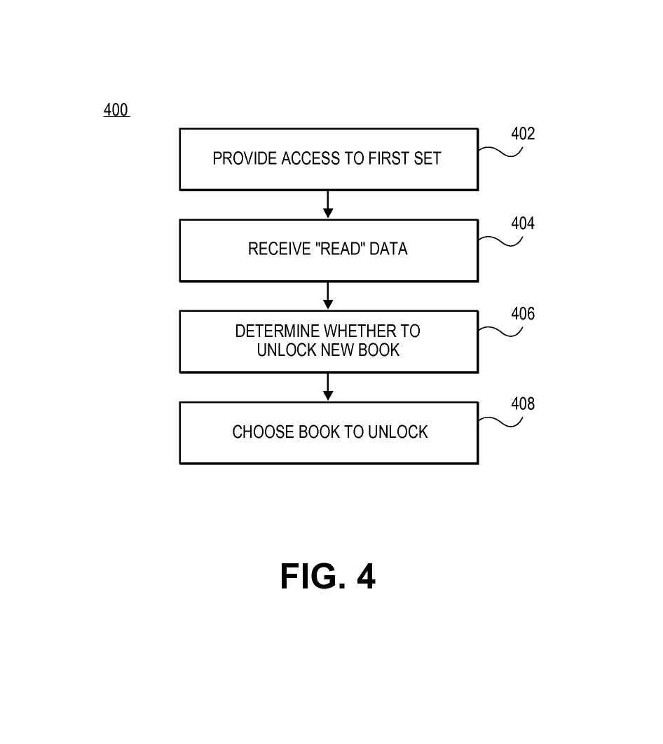

FIG. 4 is a flowchart 400 illustrating the steps of an example approach for progressive unlocking of e-book content, according to some example embodiments.

At 402, access to a first set of e-books is provided, where this first set is a subset of a second set, which in one example comprised the entire library of available e-books. Access to the entire library is restricted; that is, only books in the first set may be accessed and read by a user. When e-books from the larger second set (i.e., the entire library, which may be added to over time) are placed in the first set (e.g., “unlocked”), then a user may access them.

In an example, when a book is placed in the first set, it is no longer considered part of the second set (the entire library) for purposes of choosing future books, as will be discussed herein. In an example, the first set could be a “starter set” of e-books provided to a user who has just initialized her account. The starter set may be based on demographic information about the user, such as age, gender, reading interests, etc. Given this information, a representative swath of the larger library may be selected to populate the first set. In another example, the first set may comprise all books made available to a user, via the “unlocking” approaches described herein, in addition to whatever books may have comprised the starter set. For purposes of the specification, “unlocking” an e-book is considered to be “granting access” to the e-book or making an e-book “available” from the larger universe of e-books that do not comprise the first, smaller set.

At 404, data is received indicating that one of the e-books in the first set has been read. In an example, a book being “read” may comprise displaying all or a subset of the total pages comprising the e-book, said subset being configurable by a user and/or administrator. In an example, a user who “speed-reads” a book; i.e., flips through the display of pages so rapidly that it is determined that no actual reading has taken place, may generate data that indicates that the e-book has been accessed but not read. The determination of “speed reading” is configurable by detecting data describing the consumption of a book, which in various examples may comprise: the total time spent on each page, the total time spent on the e-book, the difficulty of the e-book in relation to the amount of time spent on the e-book, the age and/or reading level of the designated user, and other criteria.

At 406, after data is received indicating that one of the e-books in the first set has been “read,” as that may be defined in the particular example, it is determined whether access to one or more e-books in the second set (e.g., the entire library not including book in the first set) should be granted. In various examples, this step may comprise identifying which e-books have been read by the user. Data about the e-books and their consumption may be analyzed, such as the order in which the books have been read and the difficulty of the e-books. As described earlier, various approaches of determining reading difficulty and quantifying the difficulty of books into a numerical score are known in the art.

A time factor related to the e-books that have been read may be calculated. In an example, this time factor comprises a rolling window of time in which various e-books have been read. For example, a time factor of one week may be calculated and the difficulty of the e-books read in that week (which may be the last week) is analyzed. A decision whether to grant access to a new e-book may in one example be based on analyzing the difficulty of the e-books identified as read and the time factor. In an example, the difficulty of the e-books read by a user over a period of time may be averaged, or the progression of difficulty in the period of time may be calculated, and based on this analysis, a decision is made whether to unlock a new e-book.

At 408, if the determination is made to unlock a new e-book, then the new e-book is chosen based on an analysis of books previously read by the user (or in another example, based on all the books populating the first set). As discussed herein, this analysis may comprise data related to the relative difficulty of the read e-books, as well as the user's reading level, at a particular point in time or over a period of time. If a new e-book is unlocked, then that e-book is “placed” in the first set; that is, the e-book is now considered to be in the “user's library” (i.e., the first set) and will not be considered part of the second set (i.e., the entire library) for purposes of choosing a future e-book to unlock. In some examples, various user interface elements are provided to display the e-books comprising the user's library, such as a bookshelf metaphor wherein the covers of the e-books are displayed.

In an example, choosing the e-book to be unlocked may involve one or more steps. For example, the entire library should be checked to exclude books already in the user's library (i.e., the first set) from the “candidate set” of books from which the e-book to be unlocked may be chosen. A target reading level may be calculated which may be based on the difficulty of the e-books that the user has already read. In an example, a subset of the e-books that the user has already read is analyzed; for example, only those books read in the last week.

The target reading level may be adjusted; for example, based on the pace at which the user has read the books in her library or the subset of the e-books that the user has read. This reading level may comprise a numerical score, calculated according to methods known in the art. In an example, if the user has a reading score of 50 on a scale of 1-100, and the user has read “difficult” books at a faster-than-normal pace, then the user's reading score may be adjusted to 60. Likewise, a user's reading score may be adjusted downward in various examples where the user is reading material of a particular difficulty at a slower pace than considered appropriate for that level of difficulty.

The target reading level, whether comprising a numerical score or some other measure, is compared to the difficulty level of the entire library, and a list of “candidate e-books” is chosen based on the comparison, wherein the candidate e-books comprise the set from which one or more e-books will be chosen to be unlocked. In various examples, the candidate set of e-books may be chosen at another point and based on other criteria.

In an example, the candidate set of e-books is sorted based on various criteria. For example, audio narrated books may be sorted to the top if appropriate. Every Nth unlock may be a “special” unlock, one example being where books that have been designated as “quality” e-books are designated as a subset of the second set (i.e., the entire library). This “quality” designation may be the result of human curation. The purpose is to make sure that a reader gets a “good” book every so often. Aggregated thematic content chosen by the user over the last N books read may be compared to the candidate set and books matching that criteria sorted to the top.

In an example, access to a new e-book may be granted automatically after a configurable threshold number of e-books have been added to the entire library. This way, as new e-books are added to the overall library, a user is assured of getting one of them to read. In another example, if a user hasn't read an e-book within a threshold amount of time, then a new e-book is unlocked. This way, users whose activity has lapsed, perhaps due to flagging interest in the books available to him, is presented with a new e-book that may stimulate his interest in reading.

In various examples, e-books selected to be unlocked may come from a candidate set, as described herein, or may be selected from the larger library as a whole. The filtering and sorting approaches may or may not be utilized as part of granting access to a new e-book. In one example, a user interface element may be provided that displays the books in the library, and a user may select one or more of the books to populate a candidate set from which the next e-book to be unlocked will be chosen. This is a “parent mode” which allows an administrator to choose which books are appropriate for the user. Access to a new e-book is provided only from the e-books selected via this approach.

In another example, in the event that access to a new e-book is not granted, a notification may be provided indicating how many more e-books in the first set need to be read prior to granting access to an e-book in the second set.

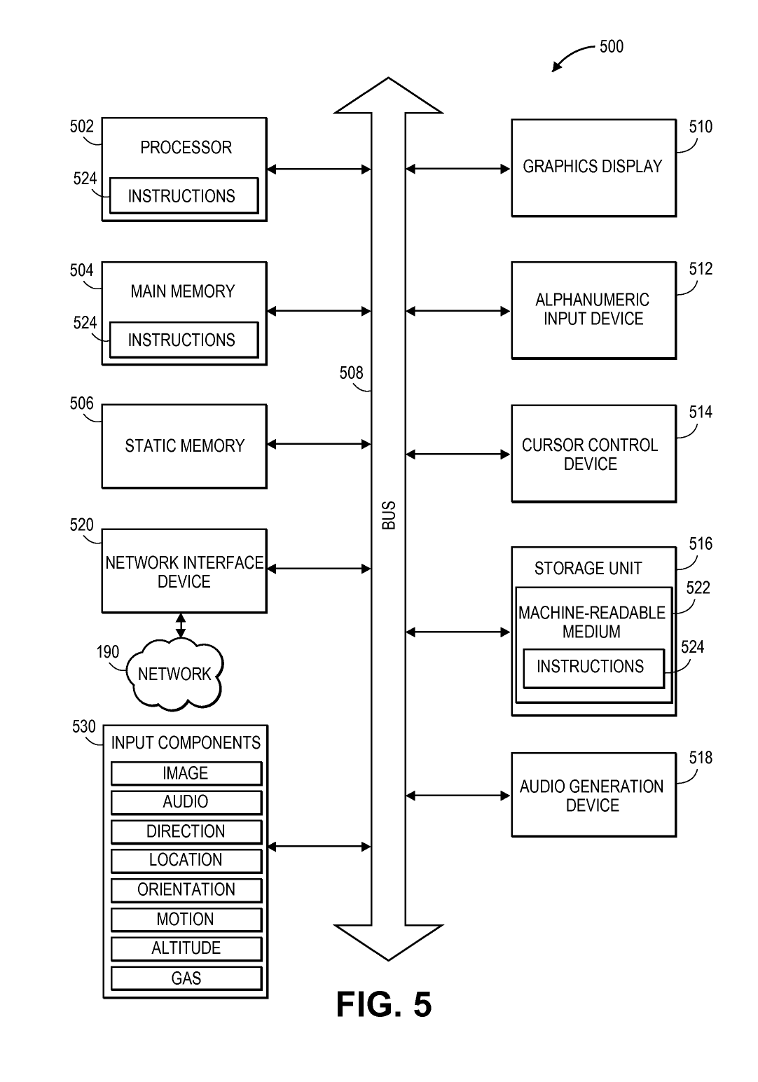

FIG. 5 is a block diagram illustrating components of a machine 500, according to some example embodiments, able to read instructions 524 from a machine-readable medium 522 (e.g., a machine-readable storage medium, a computer-readable storage medium, or any suitable combination thereof) and perform any one or more of the methodologies discussed herein, in whole or in part. Specifically, FIG. 5 shows the machine 500 in the example form of a computer system within which the instructions 524 (e.g., software, a program, an application, an applet, an app, or other executable code) for causing the machine 500 to perform any one or more of the methodologies discussed herein may be executed, in whole or in part. In alternative embodiments, the machine 500 operates as a standalone device or may be connected (e.g., networked) to other machines. In a networked deployment, the machine 500 may operate in the capacity of a server machine or a client machine in a server-client network environment, or as a peer machine in a distributed (e.g., peer-to-peer) network environment. The machine 500 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 524, sequentially or otherwise, that specify actions to be taken by that machine. Further, while only a single machine is illustrated, the term “machine” shall also be taken to include any collection of machines that individually or jointly execute the instructions 524 to perform all or part of any one or more of the methodologies discussed herein.

The machine 500 includes a processor 502 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 504, and a static memory 506, which are configured to communicate with each other via a bus 508. The processor 502 may contain microcircuits that are configurable, temporarily or permanently, by some or all of the instructions 524 such that the processor 502 is configurable to perform any one or more of the methodologies described herein, in whole or in part. For example, a set of one or more microcircuits of the processor 502 may be configurable to execute one or more modules (e.g., software modules) described herein.

The machine 500 may further include a graphics display 510 (e.g., a plasma display panel (PDP), a light emitting diode (LED) display, a liquid crystal display (LCD), a projector, a cathode ray tube (CRT), or any other display capable of displaying graphics or video). The machine 500 may also include an alphanumeric input device 512 (e.g., a keyboard or keypad), a cursor control device 514 (e.g., a mouse, a touchpad, a trackball, a joystick, a motion sensor, an eye tracking device, or other pointing instrument), a storage unit 516, an audio generation device 518 (e.g., a sound card, an amplifier, a speaker, a headphone jack, or any suitable combination thereof), and a network interface device 520.

The storage unit 516 includes the machine-readable medium 522 (e.g., a tangible and non-transitory machine-readable storage medium) on which are stored the instructions 524 embodying any one or more of the methodologies or functions described herein. The instructions 524 may also reside, completely or at least partially, within the main memory 504, within the processor 502 (e.g., within the processor's cache memory), or both, before or during execution thereof by the machine 500. Accordingly, the main memory 504 and the processor 502 may be considered machine-readable media (e.g., tangible and non-transitory machine-readable media). The instructions 524 may be transmitted or received over the network 190 via the network interface device 520. For example, the network interface device 120 may communicate the instructions 524 using any one or more transfer protocols (e.g., hypertext transfer protocol (HTTP)).

In some example embodiments, the machine 500 may be a portable computing device, such as a smart phone or tablet computer, and have one or more additional input components 530 (e.g., sensors or gauges). Examples of such input components 530 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 522 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing the instructions 524 for execution by the machine 500, such that the instructions 524, when executed by one or more processors of the machine 500 (e.g., processor 502), cause the machine 500 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
providing access to a first set of e-books, wherein the first set is a subset of a second set of e-books to which access is restricted;
receiving data indicating that one of the e-books in the first set has been read;
determining whether access to an e-book in the second set should be granted; and
based on the determination, granting access to an e-book in the second set, wherein the e-book in the second set is chosen based upon an analysis of previously-read e-books in the first set, and wherein the e-book in the second set is placed in the first set.

2. The method of claim 1, wherein determining whether access to an e-book in the second set should be granted comprises:
identifying which e-books in the first set have been read;
analyzing the difficulty of the e-books in the first set which have been identified as read;
calculating one or more time factors related to the e-books in the first set which have been identified as read; and
granting access to an e-book in the second set based on an analysis of the difficulty of the e-books in the first set which have been identified as read and the one or more time factors.

3. The method of claim 2, wherein analyzing the difficulty of the e-books in the first set which have been identified as read comprises:
calculating a difficulty score for each e-book in the first set, wherein the factor is based on characteristics of the text of the e-book.

4. The method of claim 1, wherein choosing the e-book in the second set to which access will be granted comprises:
determining which e-books in the second set do not also belong to the first set;
determining a target reading level based on the difficulty of a subset of the e-books in the first set which have been identified as read, wherein the subset is selected based on when the e-books in the first set have been identified as read;
adjusting the target reading level based upon the pace at which the subset of the e-books in the first set have been identified as read;
selecting a list of candidate e-books by comparing the target reading level to the e-books in the second set that do not also belong to the first set;
sorting the list of candidate e-books based on predetermined criteria; and
granting access to an e-book in the second set based on the sorted order.

5. The method of claim 1, wherein determining whether access to an e-book in the second set should be granted comprises:
determining whether a threshold amount of e-books have been added to the second set;
if the threshold amount of e-books has been added to the second set, granting access to a subset of the e-books that have been added to the second set.

6. The method of claim 1, wherein determining whether access to an e-book in the second set should be granted comprises:
determining whether a threshold amount of time has elapsed since the last time an e-book in the first set has been identified as read;
if the threshold amount of time has elapsed, granting access to an e-book in the second set.

7. The method of claim 1, further comprising:
determining how many times access to an e-book in the second set of e-books has been granted;
based upon the determination, granting access to an e-book in the second set, wherein the e-book is designated as belonging to a subset of the second set.

8. The method of claim 1, wherein choosing the e-book in the second set to which access will be granted comprises:
providing a user interface element displaying a plurality of e-books in the second set;
receiving instructions selecting one or more e-books in the second set;
granting access to an e-book of the selected one or more e-books.

9. The method of claim 1, further comprising:
if access to an e-book in the second set is not granted, providing a notification indicating how many more e-books in the first set need to be read prior to granting access to an e-book in the second set.

10. A non-transitory machine-readable storage medium comprising instructions that, when executed by one or more processors of a machine, cause the machine to perform operations comprising:
providing access to a first set of e-books, wherein the first set is a subset of a second set of e-books to which access is restricted;
receiving data indicating that one of the e-books in the first set has been read;
determining whether access to an e-book in the second set should be granted; and
based on the determination, granting access to an e-book in the second set, wherein the e-book in the second set is chosen based upon an analysis of previously-read e-books in the first set, and wherein the e-book in the second set is placed in the first set.

11. The non-transitory machine-readable storage medium of claim 10, wherein determining whether access to an e-book in the second set should be granted comprises:
identifying which e-books in the first set have been read;
analyzing the difficulty of the e-books in the first set which have been identified as read;
calculating one or more time factors related to the e-books in the first set which have been identified as read; and
granting access to an e-book in the second set based on an analysis of the difficulty of the e-books in the first set which have been identified as read and the one or more time factors.

12. The non-transitory machine-readable storage medium of claim 11, wherein analyzing the difficulty of the e-books in the first set which have been identified as read comprises:
calculating a difficulty score for each e-book in the first set, wherein the factor is based on characteristics of the text of the e-book.

13. The non-transitory machine-readable storage medium of claim 10, wherein choosing the e-book in the second set to which access will be granted comprises:
determining which e-books in the second set do not also belong to the first set;
determining a target reading level based on the difficulty of a subset of the e-books in the first set which have been identified as read, wherein the subset is selected based on when the e-books in the first set have been identified as read;
adjusting the target reading level based upon the pace at which the subset of the e-books in the first set have been identified as read;
comparing the target reading level to the e-books in the second set that do not also belong to the first set to select a list of candidate e-books;
sorting the list of candidate e-books based on predetermined criteria; and
granting access to an e-book in the second set based on the sorted order.

14. The non-transitory machine-readable storage medium of claim 10, wherein determining whether access to an e-book in the second set should be granted comprises:
determining whether a threshold amount of e-books have been added to the second set;
if the threshold amount of e-books has been added to the second set, granting access to a subset of the e-books that have been added to the second set.

15. The non-transitory machine-readable storage medium of claim 10, wherein determining whether access to an e-book in the second set should be granted comprises:
determining whether a threshold amount of time has elapsed since the last time an e-book in the first set has been identified as read;
if the threshold amount of time has elapsed, granting access to an e-book in the second set.

16. The non-transitory machine-readable storage medium of claim 10, further comprising:
determining how many times access to an e-book in the second set of e-books has been granted;
based upon the determination, granting access to an e-book in the second set, wherein the e-book is designated as belonging to a subset of the second set.

17. The non-transitory machine-readable storage medium of claim 10, wherein choosing the e-book in the second set to which access will be granted comprises:
providing a user interface element displaying a plurality of e-books in the second set;
receiving instructions selecting one or more e-books in the second set;
granting access to an e-book of the selected one or more e-books.

18. The non-transitory machine-readable storage medium of claim 10, further comprising:
if access to an e-book in the second set is not granted, providing a notification indicating how many more e-books in the first set need to be read prior to granting access to an e-book in the second set.

19. A device for e-book consumption, comprising:
an access module configured to provide access to a first set of e-books, wherein the first set is a subset of a second set of e-books to which access is restricted;
a data module configured to receive data indicating that one of the e-books in the first set has been read;
an access module configured to determine whether access to an e-book in the second set should be granted; and
based on the determination, an access module configured to grant access to an e-book in the second set, wherein the e-book in the second set is chosen based upon an analysis of previously-read e-books in the first set, and wherein the e-book in the second set is placed in the first set.

20. The device of claim 19, wherein the access module configured to determine whether access to an e-book in the second set should be granted is further configured to:
identify which e-books in the first set have been read;
analyze the difficulty of the e-books in the first set which have been identified as read;
calculate one or more time factors related to the e-books in the first set which have been identified as read; and
grant access to an e-book in the second set based on an analysis of the difficulty of the e-books in the first set which have been identified as read and the one or more time factors.
